(19) United States
(12) Patent Application Publication
(10) Pub. No.: US 2024/0067249 A1
(43) Pub. Date: Feb. 29, 2024

(54) ONE-HAND OPERATED WHEEL ORIENTATION STRUCTURE AND CHILD CARRIER

(71) Applicant: WONDERLAND SWITZERLAND AG, Steinhausen (CH)

(72) Inventor: Mingxing SUN, Steinhausen (CH)

(21) Appl. No.: 18/259,847

(22) PCT Filed: Dec. 29, 2021
(86) PCT No.: PCT/EP2021/087793

§ 371 Date: Jun. 29, 2023

(30) Foreign Application Priority Data
Dec. 29, 2020 (CN) 202023250598.X

(51) Int. Cl. B62B 7/04

(52) U.S. Cl. CPC B62B 7/042; B62B 9/20; B62B 2301/0463

(57) ABSTRACT

A one-hand operated wheel orientation structure and a child carrier including the same. The one-hand operated wheel orientation structure includes an orientation operating portion arranged on the frame of a child carrier; a plurality of wheel orientation assemblies to lock or unlock the orientation of the corresponding wheel set; and a plurality of traction devices arranged corresponding to the wheel orientation assemblies one by one, one end of each of the traction devices is connected to the orientation operating portion, and the other end of each of the traction devices is connected to each of the wheel orientation assemblies, respectively. The actuation action or release action of the orientation operating portion is transferred to the wheel orientation assemblies through the traction devices, respectively, to unlock or lock the orientation of the corresponding wheel set.

### CROSS-REFERENCE TO RELATED APPLICATIONS

The present application is a national phase application under 35 U.S.C. 371 of International Application No. PCT/EP2021/087793 filed on Dec. 29, 2021, which claims priority to Chinese Application No. 202023250598.X filed on Dec. 29, 2020, the entire contents of which are incorporated herein by reference.

### TECHNICAL FIELD

The present disclosure relates to a wheel orientation structure, in particular, to a one-hand operated wheel orientation structure. More specifically, the present disclosure relates to a one-hand operated wheel orientation structure and a child carrier including the same.

### BACKGROUND

In order to facilitate forward or backward movement, universal wheel structures are generally used for child carriers such as strollers, wheeled cribs, etc. in the market. However, when the wheels of the child carrier may be movable in an arbitrary direction, it is difficult to manipulate the movement of the child carrier or control the steering of the child carrier. Therefore, it is necessary to provide a wheel orientation device on the front wheel or the rear wheel.

The orientation device of the existing child carrier usually has a complicated structure. Moreover, a user needs to stop the child carrier first, and directionally lock each of the wheels respectively, and then stop and unlock the wheels after steering the child carrier. That is to say, such orientation device is not only cumbersome and time-consuming to operate, but also requires to be operated by both hands of the user. Thus, this kind of child carrier is extremely difficult to operate for the user who may push the carrier by one hand, and a heavy object is carried by the other hand, for example.

Therefore, in one or more embodiments it is useful to provide a wheel orientation structure having a simple structure, convenient to operate, and capable of one-hand operation.

### SUMMARY

An objective of an embodiment of the present disclosure is to provide a wheel orientation structure with simple structure, convenient operation, and easy disassembling and maintenance.

Another objective of an embodiment of the present disclosure is to provide a wheel orientation structure capable of realizing one-hand operation.

Another objective of an embodiment of the present disclosure is to provide a wheel orientation structure that simultaneously realizes the oriented unlocking and oriented locking of wheels or wheel sets in a one-hand operated manner.

Another objective of an embodiment of the present disclosure is to provide a child carrier having the wheel orientation structure as mentioned above.

In order to achieve at least one of the above objectives, one or more embodiments of the present disclosure provide a one-hand operated wheel orientation structure. The one-hand operated wheel orientation structure includes an orientation operating portion arranged on a frame; a plurality of wheel orientation assemblies locking or unlocking the orientation of a corresponding one of wheel sets; a plurality of traction devices arranged corresponding to the plurality of wheel orientation assemblies one by one, one end of each of the plurality of traction devices being connected to the orientation operating portion, and the other end of each of the plurality of traction devices being connected to each of the plurality of wheel orientation assemblies, respectively. An actuation action or a release action of the orientation operating portion is transferred to the wheel orientation assemblies through the traction devices, so as to unlock or lock the corresponding one of wheel sets.

In at least one embodiment, the orientation operating portion includes a turntable rotatably mounted on the frame, wherein the plurality of traction devices are respectively connected with the turntable by being evenly distributed along a circumference of the turntable, and the actuation action of the orientation operating portion is a rotation action of the turntable in one direction to unlock the corresponding one of wheel sets.

In at least one embodiment, the orientation operating portion further includes a handle fixedly connected to the turntable and capable of being switched between a locked position and an unlocked position to rotate together with the turntable about the same center.

In at least one embodiment, the orientation operating portion further includes a button inserted on the frame and movably connected to the turntable, and capable of being switched from a locked position to an unlocked position by means of pressing, thereby rotating the turntable.

In at least one embodiment, the turntable has a turntable engaging portion, and the button has a button operating portion that accepts a pressing operation and a button engaging portion connected to the turntable engaging portion, engagement of the button engaging portion and the turntable engaging portion enables a linear movement of the button to be converted into a rotary movement of the turntable.

In at least one embodiment, the turntable engaging portion is a cylindrical convex portion, the button engaging portion is an elongated slot hole, and the convex portion is inserted into the elongated slot hole and movable in the elongated slot hole.

In at least one embodiment, the plurality of wheel orientation assemblies are two wheel orientation assemblies, and the plurality of traction devices are two traction devices.

In at least one embodiment, the wheel orientation assembly includes: a fixing seat arranged on the frame; a rotation seat arranged on a wheel frame of the wheel set, connected to the fixing seat, and capable of rotating about an axis perpendicular to the ground relative to the fixing seat; an orientation member connected to one of the plurality of traction devices, and movably arranged in an orientation member holding hole of the fixing seat, wherein the orientation member has an extended position and a retracted position, in the retracted position, the orientation member is only accommodated in the orientation member holding hole of the fixing seat, so that the rotation seat is capable of rotating relative to the fixing seat, thereby unlocking an orientation of the corresponding one of wheel sets; and in the extended position, the orientation member is accommodated in the orientation member holding hole of the fixing seat and accommodated in an orientation member receiving hole of the rotation seat to prevent the rotation seat from rotating relative to the fixing seat, thereby locking the orientation of the corresponding one of wheel sets; and an elastic member seated in the fixing seat, the elastic member having one end abutting against the fixing seat, and the other end abutting against the orientation member to apply a force to the orientation member to move towards the orientation member receiving hole.

In at least one embodiment, the traction device is connected to one end of the orientation member inserted into the orientation member holding hole, wherein the actuation action of the orientation operating portion enables the plurality of traction devices to simultaneously pull the corresponding orientation member so that the corresponding orientation member is disengaged from the corresponding orientation member receiving hole, thereby unlocking the orientation of the wheel set.

In at least one embodiment, the release action of the orientation operating portion enables the traction devices to simultaneously release the plurality of traction to the corresponding orientation member so that the corresponding orientation member is inserted into the corresponding orientation member holding hole under the action of the elastic member, thereby locking the orientation of the wheel set.

One or more embodiments of the present disclosure also provide a child carrier including a frame; a wheel set arranged on the frame; and the one-hand operated wheel orientation structure as described above, wherein the orientation operating portion of the wheel orientation structure is arranged on the frame grip portion of the child carrier.

The one-hand operated wheel orientation structure of one or more embodiments of the present disclosure has the beneficial technical effects of simple structure, convenient operation, and easy disassembling and assembling, thereby facilitating the convenience of regular maintenance. One or more embodiments of the present disclosure can simultaneously realize the oriented unlocking and oriented locking of the wheels or wheel sets by one hand operation, greatly increasing the convenience and experience of the user. Also, one or more embodiments of the present disclosure can improve production efficiency and save production costs.

### BRIEF DESCRIPTION OF THE DRAWINGS

The accompanying drawings are included herein to provide a further understanding of the present disclosure, and are incorporated into this specification to constitute a part of the specification of the present application. The accompanying drawings illustrate embodiments of the present disclosure and are used together with the following description to illustrate the concept of the present disclosure.

FIG. 1 shows a perspective view of a child carrier with a one-hand operated wheel orientation structure according to an embodiment of the present disclosure.

FIG. 2 shows a schematic view of connection relationship of various parts in the wheel orientation structure according to an embodiment of the present disclosure.

FIG. 3 shows a schematic cross-sectional view of an orientation operating portion when the wheel orientation structure is in an oriented locking state according to an embodiment of the present disclosure.

FIG. 4 shows a schematic cross-sectional view of a wheel orientation assembly when the wheel orientation structure is in the oriented locking state according to an embodiment of the present disclosure.

FIG. 5 shows a schematic cross-sectional view of the orientation operating portion when the wheel orientation structure is in an oriented unlocking state according to an embodiment of the present disclosure.

FIG. 6 shows a schematic cross-sectional view of the wheel orientation assembly when the wheel orientation structure is in the oriented unlocking state according to an embodiment of the present disclosure.

FIG. 7 shows a schematic cross-sectional view of the orientation operating portion when the wheel orientation structure is in an oriented locking state according to another embodiment of the present disclosure.

FIG. 8 shows a schematic cross-sectional view of the orientation operating portion when the wheel orientation structure is in an oriented unlocking state according to another embodiment of the present disclosure.

Reference numbers are as follows:

| | |
|---|---|
| 1 | child carrier |
| 10 | frame |
| 11 | frame grip portion |
| 20 | wheel set |
| 21 | first wheel |
| 22 | second wheel |
| 30 | one-hand operated wheel orientation structure |
| 310 | orientation operating portion |
| 311 | turntable |
| 312 | handle |
| 320 | first wheel orientation assembly |
| 321 | fixing seat |
| 3211 | orientation member holding hole |
| 322 | rotation seat |
| 3221 | orientation member receiving hole |
| 323 | orientation member |
| 324 | elastic member |
| 330 | second wheel orientation assembly |
| 340 | first traction device |
| 350 | second traction device |
| 410 | orientation operating portion |
| 411 | turntable |
| 4111 | turntable engaging portion |
| 413 | button |
| 4131 | button operating portion |
| 4132 | button engaging portion |
| C | clockwise direction |
| D | counterclockwise direction |
| X | axis |

### DETAILED DESCRIPTION

Hereinafter, exemplary embodiments of the present disclosure will be described in detail with reference to the accompanying drawings. Although various modifications and alternative forms may be made to the present disclosure, specific embodiments are shown in the accompanying drawings as examples. However, the present disclosure should not be construed as limiting the embodiments set forth herein; on the contrary, the present disclosure would cover all modifications, equivalents, and alternatives falling within the spirit and scope of the present disclosure.

In the following, the present disclosure will be described in detail with reference to the accompanying drawings.

The present disclosure is applicable to the field of a child carrier, such as a stroller, a baby carriage, and a wheeled crib. For the convenience of description, the child carrier 1 may be a baby carriage in one embodiment of the present disclosure.

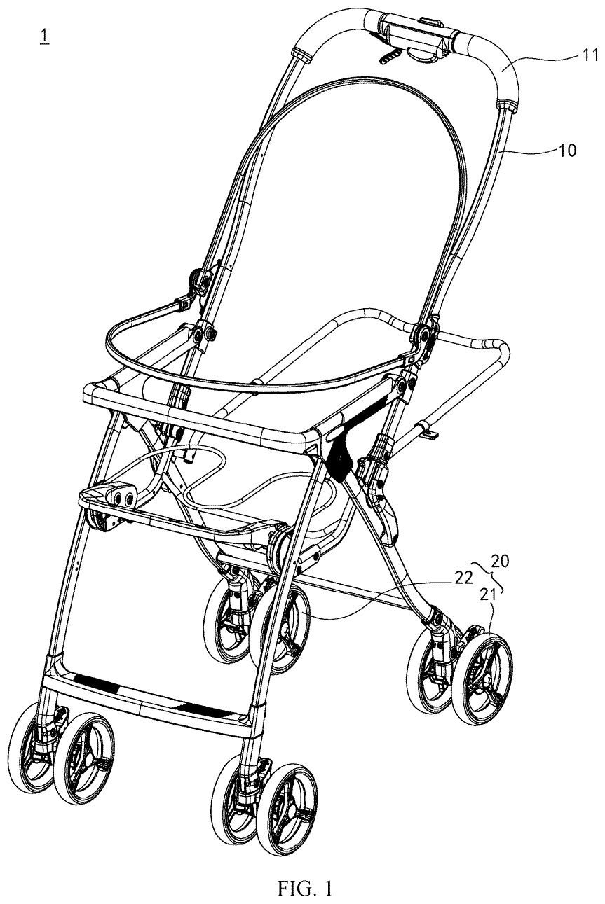

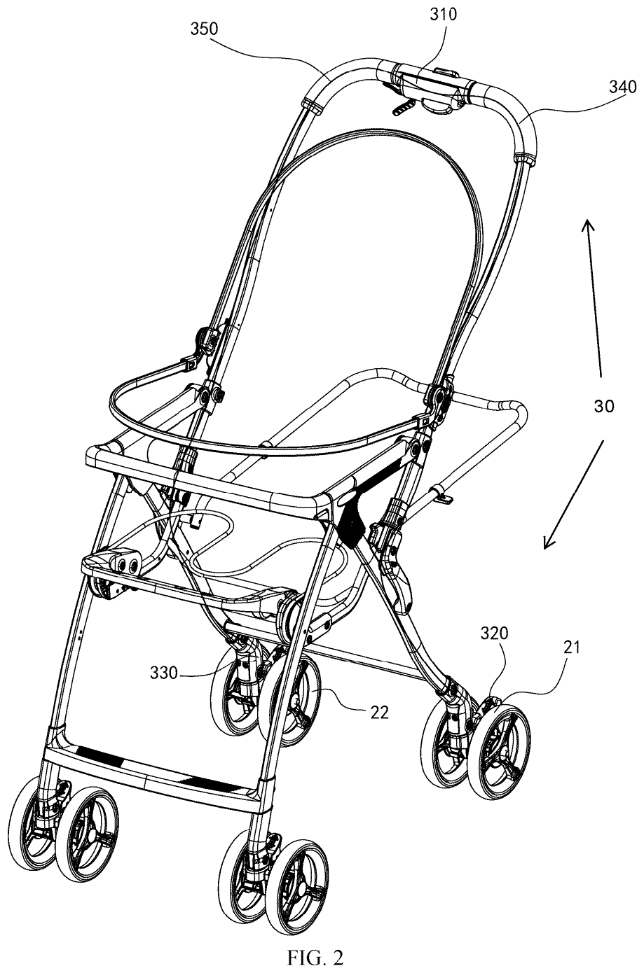

FIG. 1 shows a perspective view of a child carrier with a one-hand operated wheel orientation structure according to an embodiment of the present disclosure. FIG. 2 shows a schematic view of connection relationship of various parts in the wheel orientation structure according to an embodiment of the present disclosure.

As shown in FIG. 1, the child carrier 1 of the present disclosure has a frame 10, at least two wheel sets 20, and a wheel orientation structure 30. The wheel set 20 is arranged on the frame 10, for example, arranged on the bottom of the frame to be in contact with the ground. Each of the wheel sets 20 at least includes a first wheel 21 and a second wheel 22. In one embodiment, the wheel set 20 is a rear wheel set of the child carrier, and includes a first rear wheel and a second rear wheel. In at least one embodiment, all of these wheels are universal wheels.

With reference to FIGS. 1 and 2, the wheel orientation structure 30 includes an orientation operating portion 310, a plurality of wheel orientation assemblies 320, 330, and a plurality of traction devices 340, 350 connected between the orientation operating portion 310 and the wheel orientation assemblies 320, 330. In one embodiment, there are two wheel orientation assemblies 320, 330 and two traction devices 340, 350, and the two wheel orientation assemblies 320, 330 correspond to the two traction devices 340, 350 one by one. For example, as shown in FIG. 2, a first traction device 340 is connected between the orientation operating portion 310 and the first wheel orientation assembly 320, and a second traction device 350 is connected between the orientation operating portion 310 and the second wheel orientation assembly 330.

In particular, the orientation operating portion 310 is arranged on the frame 10, for example, at a frame grip portion 11 on the upper portion of the frame 10, and can be actuated or released by the user with one hand. The wheel orientation assemblies 320 and 330 are used to lock or unlock the orientation of the corresponding wheel set 20, respectively. For example, the first wheel orientation assembly 320 is suitable for the first wheel 21 of the wheel set 20, and the second wheel orientation assembly 330 is suitable for the second wheel 22 of the wheel set 20. The traction devices 340 and 350 may extend in an interior space of the frame 10. Each of the traction devices 340, 350 has one end connected to the orientation operating portion 310, and the other end connected to the corresponding one of the wheel orientation assemblies 320 and 330, respectively. With the above-mentioned connection relationship, the actuation or release action of the orientation operating portion 310 is transferred to the wheel orientation assemblies 320 and 330 through the traction devices 340 and 350 respectively, so as to unlock or lock the orientation of the corresponding wheel set 20.

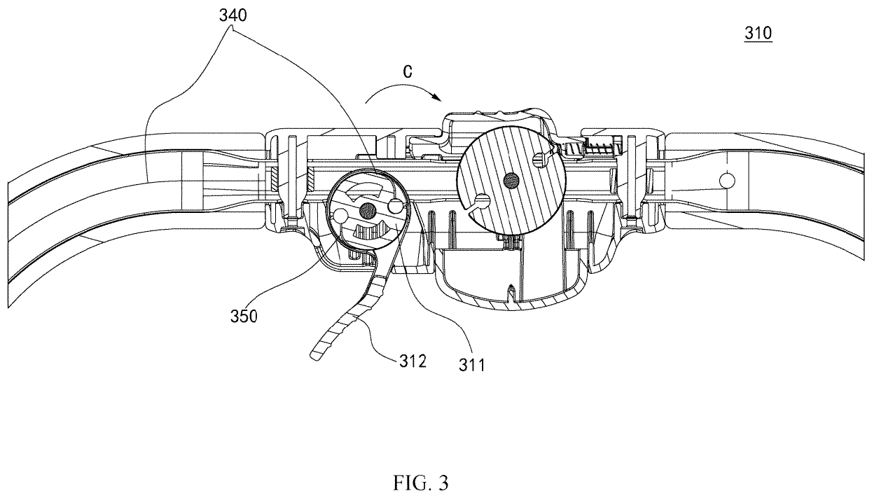

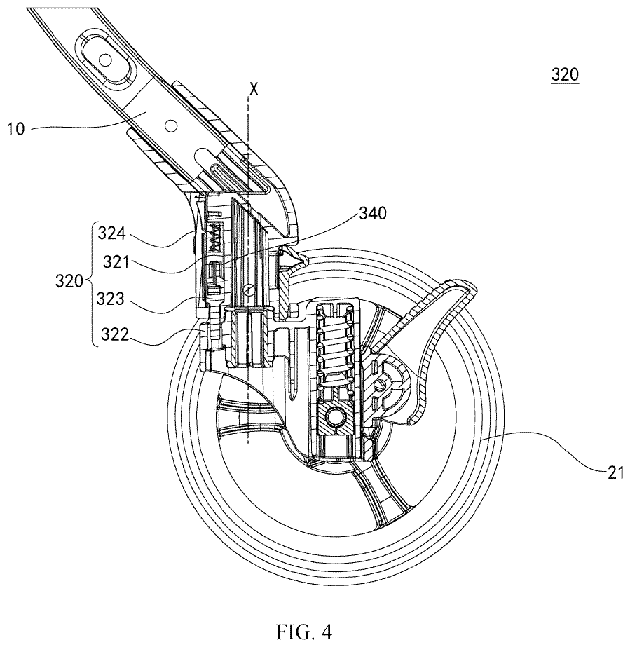

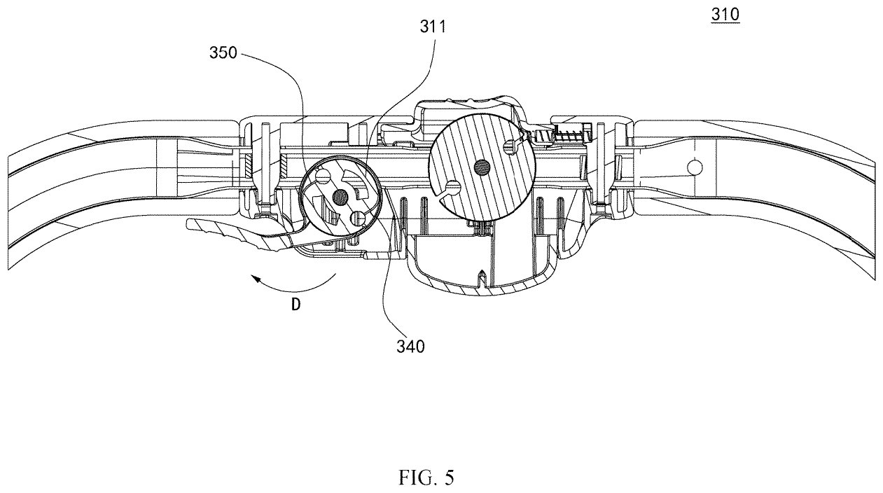

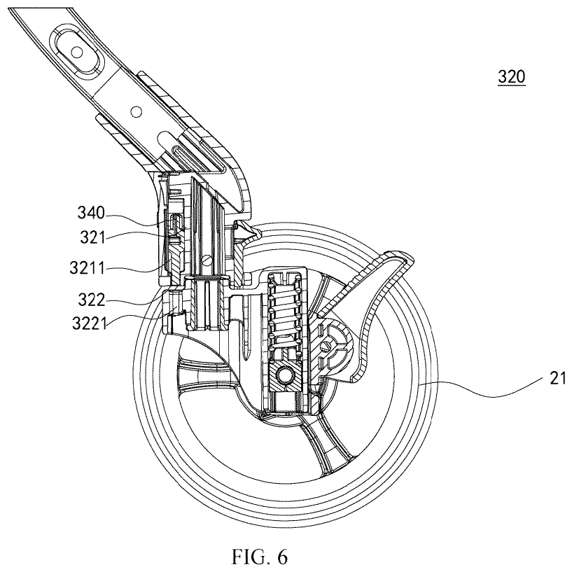

FIGS. 3 to 6 respectively show schematic cross-sectional views of an orientation operating portion and a wheel orientation assembly according to an embodiment of the present disclosure. FIGS. 3 and 4 also show the orientation operating portion 310 and the first wheel orientation assembly 320 when the wheel orientation structure 30 is in the oriented locking state. FIGS. 5 and 6 also show orientation operating portion 310 and the first wheel orientation assembly 320 when the wheel orientation structure 30 is in the oriented unlocking state.

In one embodiment of the present disclosure, as shown in FIG. 3, the orientation operating portion 310 includes a turntable 311 and a handle 312. The turntable 311 is rotatably installed on the frame 10, and the handle 312 is fixedly connected to the turntable 311. The handle 312 may be pulled and switched from a locked position (as shown in FIG. 3) to an unlocked position (as shown in FIG. 5), so as to rotate together with the turntable 311 about the same center.

In one embodiment, the actuation action of the orientation operating portion 310 is a rotation action of the turntable 311 in one direction. For example, the user can pull the handle 312 from the locked position (shown in FIG. 3) to the unlocked position (shown in FIG. 5) by one hand, so that the handle 312 may be rotated together with the turntable 311 about the same center along a clockwise direction C. Conversely, the release action of the orientation operating portion 310 is a rotation action of the turntable 311 in another direction. For example, when the handle 312 is released, the turntable 311 may rotate in a counterclockwise direction D back to the initial position, so that the handle 312 returns to the locked position (shown in FIG. 3) from the unlocked position.

The first traction device 340 and the second traction device 350 are respectively connected to the turntable 311 in a manner of being evenly distributed along the circumference of the turntable 311. In one embodiment, as shown in FIG. 3, the first traction device 340 may be a first steel wire, and the second traction device 350 may be a second steel wire. These two steel wires may be wound around the turntable 311 in the circumferential direction, and may be connected to the turntable 311 through holes circumferentially distributed on a surface of the turntable 311, and the holes circumferentially distributed on the surface of the turntable 311 may be positioned on opposite sides of the turntable 311.

A plurality of wheel orientation assemblies in one embodiment of the present disclosure may have the same structure, and respectively include a fixing seat, a rotation seat, an orientation member, and an elastic member. For ease of understanding, the connection relationship and operation mode between the orientation operating portion of the wheel orientation structure 30 and the wheel orientation assemblies and the traction devices according to the present disclosure will be described below by taking the first wheel orientation assembly 320 as an example.

In one embodiment, as shown in FIG. 4, the first wheel orientation assembly 320 includes a fixing seat 321, a rotation seat 322, an orientation member 323, and an elastic member 324.

The fixing seat 321 is arranged on the frame 10 close to the first wheel 21, and has an orientation member holding hole 3211 for accommodating the orientation member 323.

The rotation seat 322 is arranged on the wheel frame of the first wheel 21 of the wheel set 20, and has an orientation member receiving hole 3221 for receiving the orientation member 323 when the orientation member 323 is selectively engaged with the rotation seat 322. The rotation seat 322 is connected to the fixing seat 321, for example in a pivotable manner, and may rotate relative to the fixing seat 321 about an axis X perpendicular to the ground.

The orientation member 323 is connected to the first traction device 340 and is movably arranged in the orientation member holding hole 3211 of the fixing seat 321. In particular, the first traction device 340 is connected to one end of the orientation member 323 inserted into the orientation member holding hole 3211. Corresponding to the oriented locking state and the oriented unlocking state of the wheel orientation structure 30 of the present disclosure, the orientation member 323 respectively has an extended position (as shown in FIG. 4) and a retracted position (as shown in FIG. 6). When the orientation member 323 is in the extended position, the orientation member 323 is not only accommodated in the orientation member holding hole 3211 of the fixing seat 321, but also accommodated in the orientation member receiving hole 3221 of the rotation seat 322, thereby restricting the relative rotation between them; and when the orientation member 323 is in the retracted position, the orientation member 323 is only accommodated in the orientation member holding hole 3211 of the fixing seat 321, thereby not restricting the relative rotation between the fixing seat 321 and the rotation seat 322.

The elastic member 324 is seated in the fixing seat 321, one end of the elastic member abuts against the fixing seat 321, and the other end abuts against the orientation member 323, so as to apply a force to the orientation member 323 to move towards the orientation member receiving hole 3221 of the rotation seat 322.

With the wheel orientation structure 30 provided by the present disclosure, the user may complete the oriented locking and oriented unlocking of the wheel set by one-hand operation. Hereinafter, the oriented locking state and the oriented unlocking state of the wheel orientation assembly according to an embodiment of the present disclosure will be described with reference to FIGS. 3 to 6, respectively.

As shown in FIGS. 3 and 4, the wheel orientation structure 30 in the normal state is in the oriented locking state. That is, the orientation operating portion 310 is not actuated, and the orientation member 323 of the wheel orientation assembly 320 is not pulled by the first traction device 340 to move away from the orientation member receiving hole 3221 of the rotation seat 322, thus the orientation member 323 is in its extended position so that the rotation seat 322 is prevented from rotating relative to the fixing seat 321. Therefore, the orientation of the wheel set 20 is locked.

When the orientation of the wheel set 20 needs to be unlocked, that is, the wheel orientation structure 30 is switched from the oriented locking state to the oriented unlocking state, the actuation action of the orientation operating portion 310 enables the first traction device 340 and the second traction device 350 to simultaneously pull the corresponding orientation member, so that the corresponding orientation member is disengaged from the corresponding orientation member receiving hole, thereby realizing the oriented unlocking of the wheel set 20.

For example, the user may pull the handle 312 of the orientation operating portion 310 by one hand, and the handle 312 rotates the turntable 311 in the clockwise direction C, so that the first traction device 340 and the second traction device 350 are simultaneously wound around the turntable 311 in the clockwise direction, thereby pulling the corresponding orientation member.

At this time, in conjunction with FIG. 6, by taking the first wheel orientation assembly 320 as an example, with the traction of the first traction device 340, the orientation member 323 is disengaged from the orientation member receiving hole 3221 of the rotation seat 322 and is in the retracted position, so that the rotation seat 322 may be rotated relative to the fixing seat 321, thereby releasing the orientation of the first wheel 21.

When it is required to re-lock the orientation of the wheel set 20, that is, the wheel orientation structure 30 is restored from the oriented unlocking state to the oriented locking state, the release action of the orientation operating portion 310 allows the first traction device 340 and the second traction device 350 to simultaneously release the traction force acting on the corresponding orientation member, and the orientation member is inserted into the orientation member holding hole of the corresponding fixing seat under the action of the corresponding elastic member, thereby re-locking the orientation of the wheel set 20.

With reference to FIGS. 3 and 4, by taking the orientation operating portion 310, the first wheel orientation assembly 320 and the corresponding first traction device 340 as an example, the user may release the handle 312 to make the turntable 311 return to the initial position along the counterclockwise direction D under the elastic action of the elastic member 324.

For example, as shown in FIG. 4, as the first traction device 340 releases the traction force to the orientation member 323, the orientation member 323 returns from the retracted position to the extended position under the action of the elastic member 324, and is partially inserted into the orientation member receiving hole 3221 of the corresponding rotation seat 322 again, so as to prevent the rotation seat 322 from being rotated relative to the fixing seat 321, thereby re-locking the orientation of the second wheel 22 of the wheel set 20.

In other embodiments of the present disclosure, the orientation operating portion 310 may also include other structures and shapes that can achieve the oriented unlocking or oriented locking of the corresponding wheel set 20 through the traction devices 340 and 350.

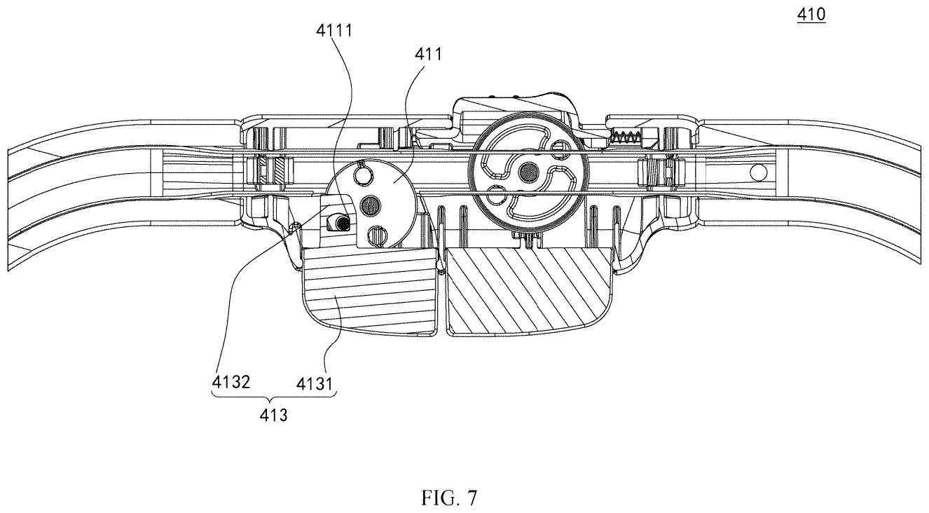

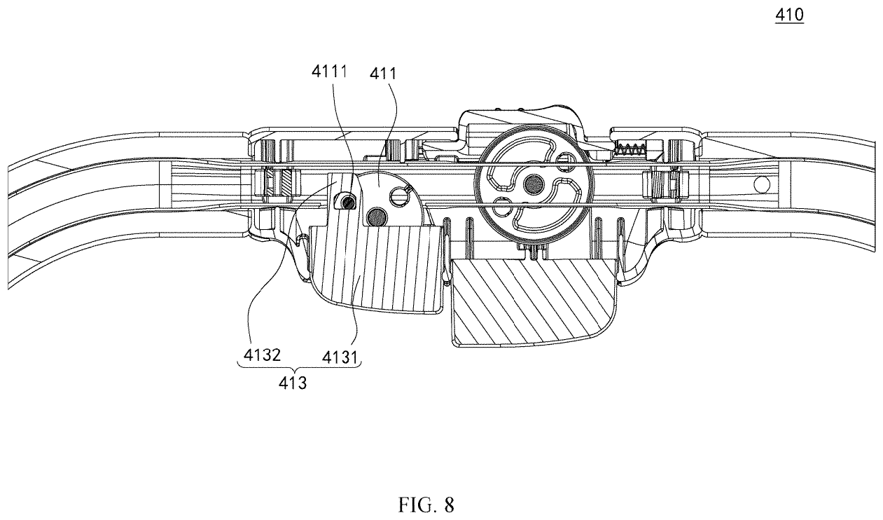

As shown in FIGS. 7 and 8, in another embodiment of the present disclosure, the orientation operating portion 410 includes a turntable 411 and a button 413. The turntable 411 is rotatably mounted on the frame 10. The button 413 is inserted on the frame 10, is movably connected to the turntable 411, and may be switched from the locked position (as shown in FIG. 7) to the unlocked position (as shown in FIG. 8) in a pressing manner, thereby driving the turntable 411 to rotate in the clockwise direction C to realize the oriented unlocking of the wheel set 20; and the button 413 is switched from the unlocked position to the locked position by releasing the pressing operation. At this time, the turntable 411 rotates in the counterclockwise direction D to realize oriented locking of the wheel set 20.

In one embodiment, the turntable 411 has a turntable engaging portion 4111, and the button 413 has a button operating portion 4131 that accepts a pressing operation and a button engaging portion 4132 connected to the turntable engaging portion 4111. The button engaging portion 4132 is engaged with the turntable engaging portion 4111 to movably connect the button 413 to the turntable 311 and convert a linear movement of the button 413 into a rotary movement of the turntable 411.

For example, the turntable engaging portion 4111 is a cylindrical convex portion, and the button engaging portion 4132 is an elongated slot hole. The convex portion is inserted into the elongated slot hole and movable in the elongated slot hole.

In this embodiment, when the orientation of the wheel set 20 needs to be unlocked, the user may press the button operating portion 4131 of the button 413 by one hand to make the button engaging portion 4132 move upwards, for example, towards the frame connected to the turntable 411, so that the engagement between the button engaging portion 4132 and the turntable engaging portion 4111 brings the turntable 411 to rotate in the clockwise direction C. As the turntable 411 rotates, the first traction device 340 and the second traction device 350 are wound on the turntable 311 in the clockwise direction to simultaneously pull the corresponding orientation members out of the orientation member receiving holes of the corresponding rotation seats, thereby releasing the orientation of the wheel set 20.

On the contrary, when the orientation of the wheel set 20 needs to be re-locked, the user may release the pressing action on the button operating portion 4131, and the turntable 411 rotates in the counterclockwise direction D back to the initial position. The first traction device 340 and the second traction device 350 release the traction action on their corresponding orientation members, so that the corresponding orientation member is inserted into the orientation member holding hole of the corresponding rotation seat under the action of the corresponding elastic member, thereby locking the orientation of the wheel set 20.

One or more embodiments of the present disclosure provide a wheel orientation assembly with simple structure, convenient operation, easy disassembling and assembling, and convenient maintenance. The wheel orientation assembly can also satisfy the user with the one-hand operation. Moreover, the wheel orientation assembly provided by one or more embodiments of the present disclosure can simultaneously realize the oriented unlocking and the oriented locking of the wheels or wheel sets by one hand, thereby greatly increasing the convenience and experience of the user.

Although relative terms such as “above” and “under” are used herein to describe the relationship of one component relative to another component, such terms are used herein only for the sake of convenience, for example, in the direction shown in the figure. It should be understood that if the referenced device is inversed upside down, a component described as “above” will become a component described as “under”. Other relative terms, such as “top”, “bottom”, “left”, “right”, etc. have similar meanings. When a structure is described as “above” another structure, it probably means that the structure is integrally formed on another structure, or the structure is “directly” disposed on another structure, or the structure is “indirectly” disposed on another structure through an additional structure.

Words such as “one”, “an/a”, “the” and “said” are used in the specification to indicate the presence of one or more elements/component parts/and others. Terms “including”, “comprising” and “having” have an inclusive meaning which means that there may be additional elements/component parts/and others in addition to the listed elements/component parts/and others. Terms “first”, “second” and “third” are used herein only as markers, and they do not limit the number of objects modified after them.

Unless otherwise defined, all terms including technical and scientific terms used herein have the same meanings as commonly understood by those of ordinary skill in the art. It should also be understood that terms should be interpreted as having meanings consistent with their meanings in the related field, and unless clearly defined herein, they will not be interpreted as idealized or overly formal meanings.

It should be understood that although the preferred embodiments are shown and described above, the present disclosure is not limited to the above specific embodiments. Without departing from the spirit and scope of the appended claims, those skilled in the art can make various modifications and variations. Therefore, it should be noted that various modifications and variations cannot be considered as going beyond the technical spirit and scope of the present disclosure.

1. A one-hand operated wheel orientation structure, wherein the one-hand operated wheel orientation structure comprises:
an orientation operating portion arranged on a frame;
a plurality of wheel orientation assemblies locking or unlocking orientation of a corresponding one of wheel sets;
a plurality of traction devices arranged corresponding to the plurality of wheel orientation assemblies one by one, one end of each of the plurality of traction devices being connected to the orientation operating portion, and the other end of each of the plurality of traction devices being connected to each of the plurality of wheel orientation assemblies, respectively;
wherein an actuation action or a release action of the orientation operating portion is transferred to the wheel orientation assemblies through the traction devices, so as to unlock or lock the corresponding one of wheel sets.

2. The one-hand operated wheel orientation structure according to claim 1, wherein the orientation operating portion comprises:
a turntable rotatably mounted on the frame, wherein the plurality of traction devices are respectively connected with the turntable by being evenly distributed along a circumference of the turntable, and the actuation action of the orientation operating portion is a rotation action of the turntable in one direction to unlock the corresponding one of wheel sets.

3. The one-hand operated wheel orientation structure according to claim 2, wherein the orientation operating portion further comprises:
a handle fixedly connected to the turntable and capable of being switched between a locked position and an unlocked position to rotate together with the turntable about the same center.

4. The one-hand operated wheel orientation structure according to claim 2, wherein the orientation operating portion further comprises:
a button inserted on the frame and movably connected to the turntable, and capable of being switched from a locked position to an unlocked position by means of pressing, thereby rotating the turntable.

5. The one-hand operated wheel orientation structure according to claim 4, wherein
the turntable has a turntable engaging portion, and the button has a button operating portion that accepts a pressing operation and a button engaging portion connected to the turntable engaging portion, wherein engagement of the button engaging portion and the turntable engaging portion enables a linear movement of the button to be converted into a rotary movement of the turntable.

6. The one-hand operated wheel orientation structure according to claim 5, wherein
the turntable engaging portion is a cylindrical convex portion, the button engaging portion is an elongated slot hole, and the convex portion is inserted into the elongated slot hole and movable in the elongated slot hole.

7. The one-hand operated wheel orientation structure according to claim 1, wherein the plurality of wheel orientation assemblies are two wheel orientation assemblies, and the plurality of traction devices are two traction devices.

8. The one-hand operated wheel orientation structure according to claim 1, wherein the wheel orientation assembly comprises:
a fixing seat arranged on the frame;
a rotation seat arranged on a wheel frame of the wheel set, connected to the fixing seat, and capable of rotating about an axis perpendicular to the ground relative to the fixing seat;
an orientation member connected to one of the plurality of traction devices, and movably arranged in an orientation member holding hole of the fixing seat, wherein the orientation member has an extended position and a retracted position, wherein, in the retracted position, the orientation member is only accommodated in the orientation member holding hole of the fixing seat, so that the rotation seat is capable of rotating relative to the fixing seat, thereby unlocking an orientation of the corresponding one of wheel sets; and wherein, in the extended position, the orientation member is accommodated in the orientation member holding hole of the fixing seat and accommodated in an orientation member receiving hole of the rotation seat to prevent the rotation seat from rotating relative to the fixing seat, thereby locking the orientation of the corresponding one of wheel sets; and
an elastic member seated in the fixing seat, the elastic member having one end abutting against the fixing seat, and the other end abutting against the orientation member to apply a force to the orientation member to move towards the orientation member receiving hole.

9. The one-hand operated wheel orientation structure according to claim 8, wherein the traction device is connected to one end of the orientation member inserted into the orientation member holding hole,
wherein the actuation action of the orientation operating portion enables the plurality of traction devices to simultaneously pull the corresponding orientation member so that the corresponding orientation member is disengaged from the corresponding orientation member receiving hole, thereby unlocking the orientation of the wheel set.

10. The one-hand operated wheel orientation structure according to claim 8, wherein the release action of the orientation operating portion enables the plurality of traction devices to simultaneously release the traction to the corresponding orientation member so that the corresponding orientation member is inserted into the corresponding orientation member holding hole under the action of the elastic member, thereby locking the orientation of the wheel set.

11. A child carrier comprising:
a framed;
a wheel set arranged on the frame; and
a one-hand operated wheel orientation structure according to claim 1,
wherein the orientation operating portion of the wheel orientation structure is arranged on a frame grip portion of the child carrier.

12. The child carrier according to claim 11, wherein the orientation operating portion comprises:
a turntable rotatably mounted on the frame, wherein the plurality of traction devices are respectively connected with the turntable by being evenly distributed along a circumference of the turntable, and the actuation action of the orientation operating portion is a rotation action of the turntable in one direction to unlock the corresponding one of wheel sets.

13. The child carrier according to claim 12, wherein the orientation operating portion further comprises:
a handle fixedly connected to the turntable and capable of being switched between a locked position and an unlocked position to rotate together with the turntable about the same center.

14. The child carrier according to claim 12, wherein the orientation operating portion further comprises:
a button inserted on the frame and movably connected to the turntable, and capable of being switched from a locked position to an unlocked position by means of pressing, thereby rotating the turntable.

15. The child carrier according to claim 14, wherein
the turntable has a turntable engaging portion, and the button has a button operating portion that accepts a pressing operation and a button engaging portion connected to the turntable engaging portion, wherein engagement of the button engaging portion and the turntable engaging portion enables a linear movement of the button to be converted into a rotary movement of the turntable.

16. The child carrier according to claim 15, wherein
the turntable engaging portion is a cylindrical convex portion, the button engaging portion is an elongated slot hole, and the convex portion is inserted into the elongated slot hole and movable in the elongated slot hole.

17. The child carrier according to claim 11, wherein the plurality of wheel orientation assemblies are two wheel orientation assemblies, and the plurality of traction devices are two traction devices.

18. The child carrier according to claim 11, wherein the wheel orientation assembly comprises:
a fixing seat arranged on the frame;
a rotation seat arranged on a wheel frame of the wheel set, connected to the fixing seat, and capable of rotating about an axis perpendicular to the ground relative to the fixing seat;
an orientation member connected to one of the plurality of traction devices, and movably arranged in an orientation member holding hole of the fixing seat, wherein the orientation member has an extended position and a retracted position, wherein, in the retracted position, the orientation member is only accommodated in the orientation member holding hole of the fixing seat, so that the rotation seat is capable of rotating relative to the fixing seat, thereby unlocking an orientation of the corresponding one of wheel sets; and wherein, in the extended position, the orientation member is accommodated in the orientation member holding hole of the fixing seat and accommodated in an orientation member receiving hole of the rotation seat to prevent the rotation seat from rotating relative to the fixing seat, thereby locking the orientation of the corresponding one of wheel sets; and
an elastic member seated in the fixing seat, the elastic member having one end abutting against the fixing seat, and the other end abutting against the orientation member to apply a force to the orientation member to move towards the orientation member receiving hole.

19. The child carrier according to claim 18, wherein the traction device is connected to one end of the orientation member inserted into the orientation member holding hole,
wherein the actuation action of the orientation operating portion enables the plurality of traction devices to simultaneously pull the corresponding orientation member so that the corresponding orientation member is disengaged from the corresponding orientation member receiving hole, thereby unlocking the orientation of the wheel set.

20. The child carrier according to claim 18, wherein the release action of the orientation operating portion enables the plurality of traction devices to simultaneously release the traction to the corresponding orientation member so that the corresponding orientation member is inserted into the corresponding orientation member holding hole under the action of the elastic member, thereby locking the orientation of the wheel set.
